(19) United States
(12) Patent Application Publication
(10) Pub. No.: US 2010/0250458 A1
(43) Pub. Date: Sep. 30, 2010

(54) CONTENT BASED SOCIAL NETWORKING SYSTEM AND METHOD

(75) Inventor: Edwin Ho, Palo Alto, CA (US)

Correspondence Address: DLA PIPER LLP (US ), 2000 UNIVERSITY AVENUE, EAST PALO ALTO, CA, 94303-2248, US

(73) Assignee: MSPOT, INC., Palo Alto, CA (US)

(21) Appl. No.: 12/414,548

(22) Filed: Mar. 30, 2009

(51) Int. Cl. G06Q 99/00; H04R 25/00

(52) U.S. Cl. 705/319; 381/370

(57) ABSTRACT

A content based social networking system and method are provided in which multiple users can interact with each other using pieces of digital content.

### FIELD

The disclosure relates to a system and method for social networking using content.

### BACKGROUND

Social networking sites that allow people to share information and communicate are well known. For example, Facebook® is a well known social networking web site and system. People use social networking sites, such as Facebook®, to send and share messages, graphical images, music, videos, and other information. It is a convenient mechanism by which to keep in touch with friends and to learn what they are doing at a particular moment in time. Similarly, the Apple Computer iPhone® has one or more applications that allow a user of the iPhone® to determine the location of their friends and learn how each friend is feeling through an input mechanism by which each friend can indicate his or her emotion (e.g., happy). Other mobile devices also have a GPS capability that enables the physical location of a mobile handset to be determined.

Digital music systems and methods are also well known. For example, the Apple Computer® iPod® and the Apple Computer® iTunes® web site allow a user to browse, select and buy one or more pieces of digital content wherein the digital content may include music, videos, applications and the like. There are also other known portable MP3 players and systems that allow a user to browse, select and buy one or more pieces of digital content. In another area, Yahoo!® Instant Messenger® will inform a first user of the name of the song that a Yahoo!® Internet radio service is currently streaming to a second user if the first user and second user are connected over Instant Messenger®.

Thus, it is desirable to provide a system and method that combines social networking with digital content and it is to this end that the disclosure is directed. It would also be desirable to combine such a system with a geographic location component (e.g., GPS).

### BRIEF DESCRIPTION OF THE DRAWINGS

FIG. 1 illustrates an implementation of an embodiment of a system for content social networking;

FIG. 2 illustrates an example of a method for content social networking;

FIG. 3 illustrates an implementation of an embodiment of the system for content social networking that incorporates geography; and

FIG. 4 illustrates a geographical embodiment for content social networking.

FIG. 5 illustrates a geographical embodiment for content social networking.

FIG. 6 illustrates an exemplary graphical user interface for a geographical embodiment for content social networking.

### DETAILED DESCRIPTION OF ONE OR MORE EMBODIMENTS

The disclosure is particularly applicable to a mixed hardware/software based digital music based networking system and it is in this context that the disclosure will be described. It will be appreciated, however, that the system and method has greater utility, such as to other implementations (software based or hardware based) and can be used with other types of digital content

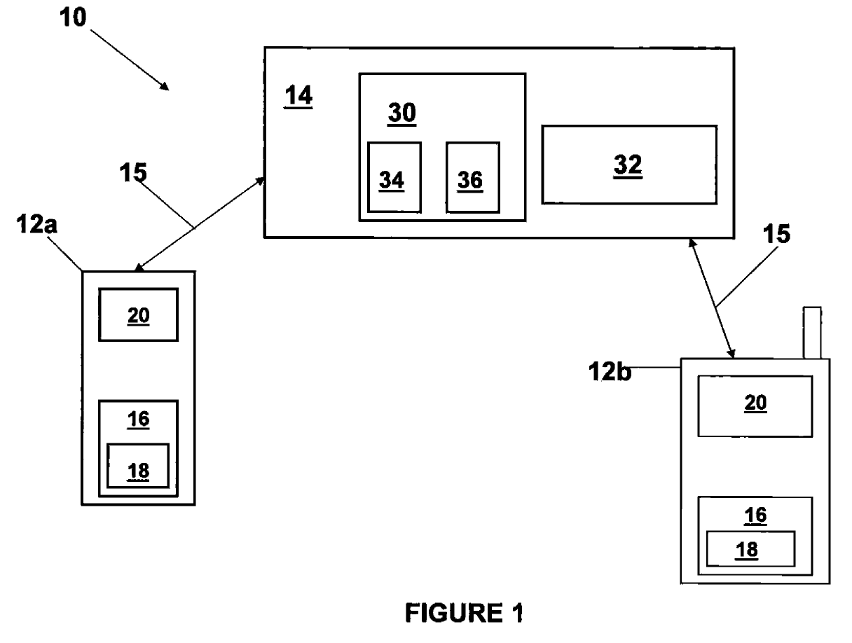

FIG. 1 illustrates an implementation of an embodiment of a system 10 for content social networking. The system may be implemented as a hardware/software based system in this implementation. The system 10 may include one or more mobile handsets 12 (such as a first mobile handset 12a used by User A and a second mobile handset 12b used by User B as shown in FIG. 1) wherein the system allows the users to socially network/flirt with each other using pieces of content. Each mobile handset 20 may be a processing unit based device with sufficient processing power, display capabilities, connectivity capabilities and memory to interact with the system. Each mobile handset, for example, may be a PDA, a mobile phone, a wireless email device (such as the Blackberry or iPhone) that may or may not have phone capabilities, handheld digital content devices (such as Ipods and the like) or other handheld device that are capable of downloading and playing digital content.

The system may further comprise a computer 14, such as one or more server computers, that can be connected to the one or more mobile handsets over one or more links 15. The links can be any type of link, such as the Internet, and can be hardwired, wireless, or some combination of the two. When the link is wireless, it can be, for example, a cellular telephone network, a WiFi network (such as an 802.11 network), a wireless data network (such as EV-DO or EDGE), or any other wireless networks. The links 15 allows the one or more mobile handsets 12 to exchange data and information with the computer 14 including digital content as described below in more detail. The computer 14 may have the appropriate one or more interfaces/circuitry that allow the mobile handsets to connect to and interact with the computer 14.

Each mobile handset 12 may further comprise a storage device 16, such as a hard disk drive, flash memory etc. that may be volatile or non-volatile, that stores one or more pieces of digital content 18 on the mobile handset 12. The digital content may be a song, a video, a picture, a podcast, a radio feed, an application, a document, music lyrics, artists' bios, concert information, or any other piece of digital content, and the storage device 16 may store one or more of these different types of digital content. Each mobile handset may also include a display 20 that allows the user to scroll through a user interface to select a piece of digital content to interact with. Each mobile handset may also include an interface (not shown) that allows the user to plug in a set of earphones, speakers etc into the mobile handset as well as a processing unit (not shown) that controls the operation of the mobile handset and a power source (not shown) to power the circuitry of the mobile handset. Each mobile handset may also include a input device that allows the user to interact with the mobile handset and connectivity circuitry (not shown) that allow the mobile handset to connect to and interact with the computer 14. For a wired link 15, the connectivity circuitry may be an interface that allows a conductor to be plugged into the mobile handset. For a wireless link 15, the connectivity circuitry may be wireless circuitry that allows the mobile handset to interact wirelessly with the computer 14.

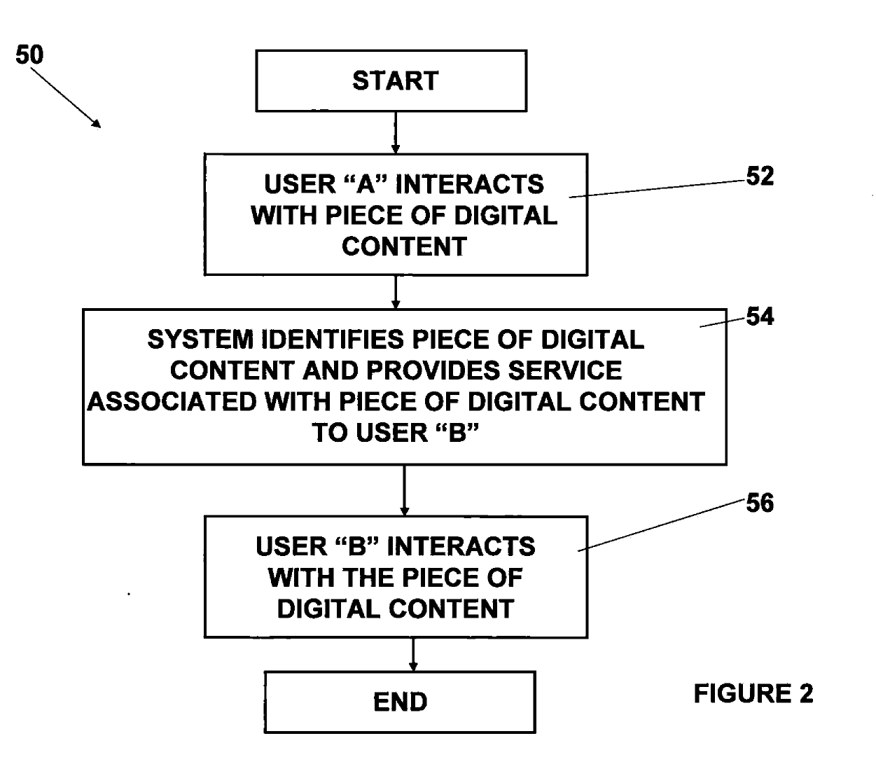

The computer 14 may further comprise one or more processing units, storage devices and interfaces (not shown) as well a content networking unit 30 (implemented as a plurality of lines of computer code that are executed by the one or more processing units of the computer 14 in this embodiment) that performs various content social networking as described below in more detail. The computer 14 may further comprise a content storage 32 (implemented as a plurality of lines of computer code that are executed by the one or more processing units of the computer 14 in this embodiment) that stores content and allows a user to catalog and organize the digital content of the user. The content storage 32 may also have a listing of the pieces of digital content for each user (a library) which are pieces of digital content that the user has the rights to interact with. The content networking unit 30 may further comprise a content identification unit 34 (implemented as a plurality of lines of computer code that are executed by the one or more processing units of the computer 14 in this embodiment) that identifies content received by the computer from the one or more mobile handsets 12 and/or determines that the received content is or is not already stored in the content storage 32. The networking unit may further comprise a network unit 36 (implemented as a plurality of lines of computer code that are executed by the one or more processing units of the computer 14 in this embodiment) that determines the networking action to perform in response to the received content as described below with reference to FIG. 2. The content networking unit 30 thus may implement social networking among its users based on pieces of digital content as described below. Now, an example of the content social networking implemented by the system shown in FIG. 1 is described with reference to FIG. 2.

FIG. 2 illustrates an example of a method 50 for content social networking that may be implemented using the system shown in FIG. 1, but may also be implemented using other systems. In the method, a user of a first mobile handset may interact with a piece of digital content (52) such as by the user playing/viewing the piece of content or browsing the piece of digital content. When the user interacts with the piece of digital content, the user optionally may also identify a person (a second user) who the user wishes to socially interact with/flirt with. The piece of digital content (or an identifier) and optionally the identity of the second user are sent to the computer 14 shown in FIG. 1. The computer 14 identifies the piece of digital content (by using the content identification unit 34 of FIG. 1, for example) and then provides a service associated with the identified piece of digital content to a user of a second mobile handset (54) such as by using the network unit 36 of FIG. 1. For example, the service may allow the first and second user to social network/flirt with each other using the piece of digital content based on the provided identifier of the second user. Alternatively, users may agree to socially network using the system and then the system will display what pieces of digital content each user, who agreed to socially network, is interacting with so that anyone can then communicate with the other users or with the system. As another alternative, the system may select one or more users to whom the received piece of digital content is to be shared based on various criteria. The criteria can include geographic proximity, membership in a social network or a “friends list,” or belonging to a common service or network. The criteria can select from a private group (e.g., a user's social network) or a public group (e.g., all wireless customers of Sprint®).

The service associated with the piece of digital content may be varied. For example, the computer 14 shown in FIG. 1 may send the piece of identified digital content to the second user with an indication that the piece of digital content originated from the first user. As another example, if the identified piece of digital content is also in the library of the second user, then the computer 14 shown in FIG. 1 may provide an indication that the piece of digital content originated from the first user and allows the second user to interact with the identified piece of digital content (56) such as by using the second mobile handset. As another example, if the identified piece of digital content is not in the library of the second user (so the second user does not have rights to interact with the identified piece of digital content), then the computer 14 shown in FIG. 1 provides an indication that the piece of digital content originated from the first user and allows the second user to purchase the identified piece of digital content (56) such as by using the second mobile handset so that the second user can then interact with the piece of digital content. In this manner, the system shown in FIG. 1 may be used by the users to social network/flirt with each other using a piece of digital content. This communication can occur through SMS messaging, communication mechanisms offered by a social network such as Facebook®, or communication mechanisms offered by an application running on the mobile handset.

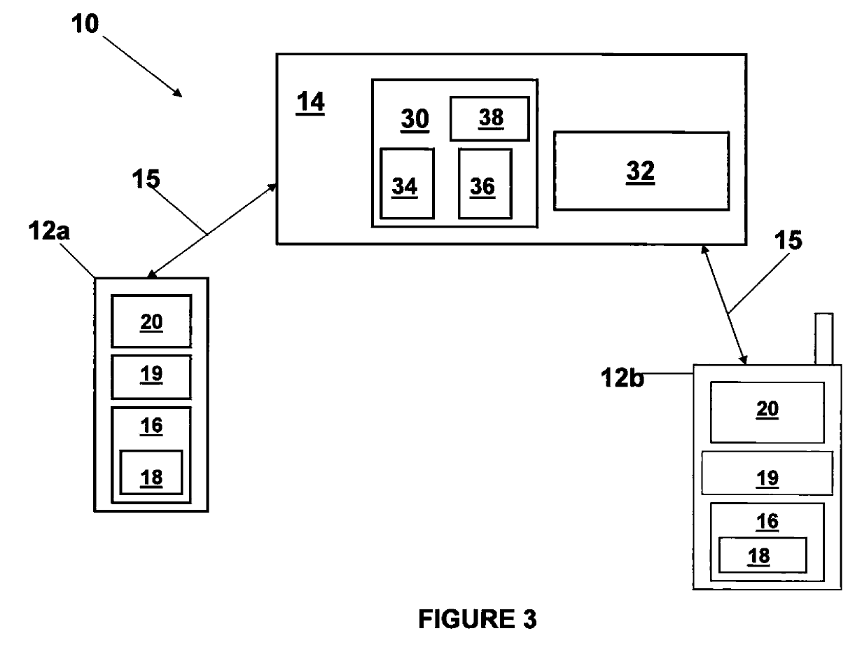

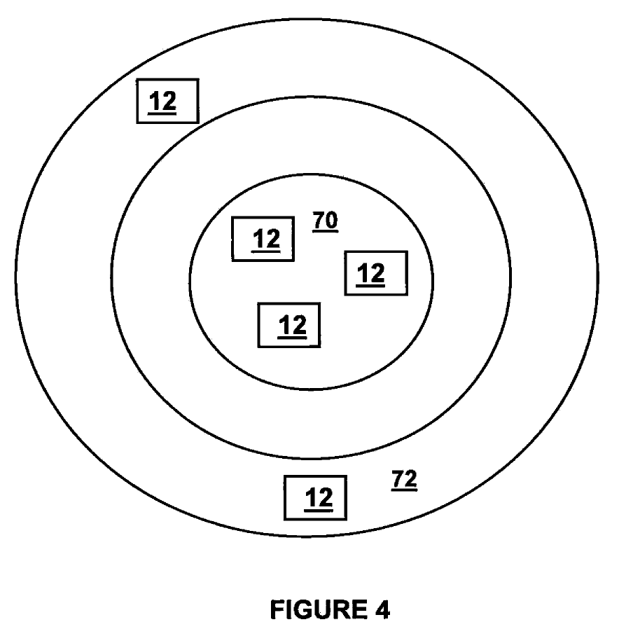

FIG. 3 illustrates an implementation of another embodiment of the system 10 for content social networking that incorporates geography. In this figure, elements with the same reference numerals as shown in FIG. 1 are the same and perform the same operations and functions and therefore will not be further described with respect to FIG. 3. In this implementation, the location of each user may be used to determine which users are able to social network/flirt with other users or the system may select the other users to social network/flirt with based on the locations of the users as described below with reference to FIG. 4. To implement this embodiment of the system, each mobile handset 12 has a unit 19 that determines the location of the mobile handset so that the location of the mobile handset can be transmitted to the computer 14. As an example, the unit 19 may be known GPS circuitry and software or it may be software that determines the position of the mobile handset based on the wireless link towers. The content networking unit 30 may further comprise a unit 38 (implemented as a plurality of lines of computer code that are executed by the one or more processing units of the computer 14 in this embodiment) that receives the location information from the mobile handsets, processes the location information as needed and supplies the location information to the network unit 36. The network unit 36, in this embodiment, may then use the location information of each mobile handset to determine which users to social network together using the piece of digital content. In particular, it is more likely that users in a particular geographic area (same town, for example) are more likely to social network and date each other than users in disparate geographic areas. Thus, as shown in FIG. 4, the mobile handsets in a first geographic area 70 may be socially networked together using the system while users in the outer geographic area 72 are not socially networked to each other due to the distance between the users. The system shown in FIG. 3 may also be used to determine the type of digital content being interacted with by users in a particular geographic area and then socially networking those users in the particular geographic area together as described above.

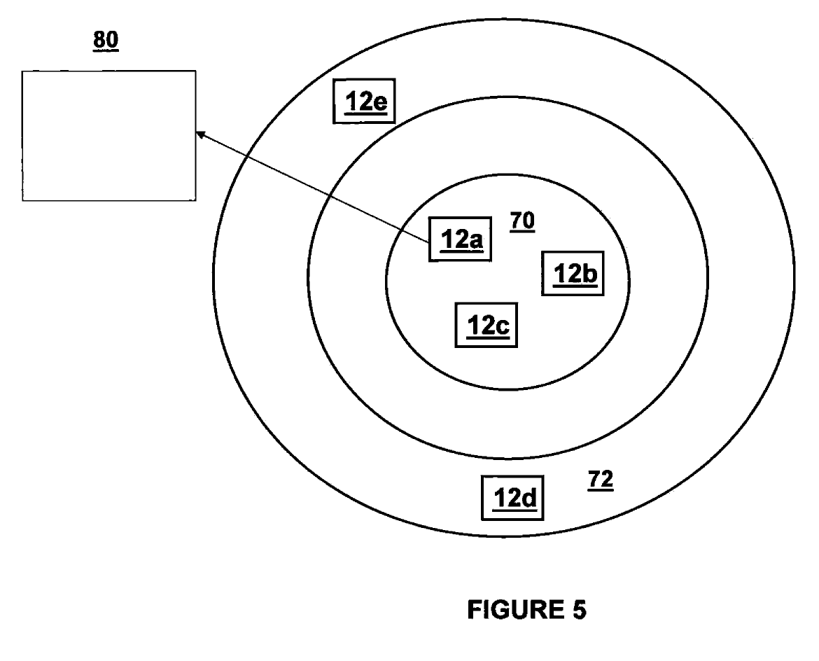

Alternatively, the system can determine the digital content that users in a particular geographic area are interacting with and then display representations of the users and their digital content to the other users of the system. For example, in FIG. 5, mobile handsets 12a, 12b, and 12c are within a first geographic area 70. The users operating those mobile handsets already are part of an existing social network, such as through Facebook®. The system shown in FIG. 3 will recognize that handsets 12a, 12b, and 12c are being operated by members of an existing social network and will then transmit information regarding one or more of them to one or more of the others. For example, mobile handset 12a at a particular moment in time may be associated with content 80. Content 80 could be a ringtone, music clip (such as a favorite song), video clip, artwork or other media content. The system shown in FIG. 3 will transmit this information to mobile handset 12b (for example), and mobile handset 12b can then show its user that mobile handset 12a and its user are associated with content 80 and are located at a particular geographical location. For example mobile handset 12b can generate a map showing first geographic area 70, the location of mobile handset 12a within that first geographic area 70, and information regarding content 80 associated with mobile handset 12a (for example, a pop-up window associating mobile handset 12a with a music clip or a depiction of a music clip that is currently playing on mobile handset 12a). In this manner, a member of a social network can learn which members of their social network are in close physical proximity to him or her, and also can learn what those members are doing at the present time by receiving information about content associated with the mobile handsets operated by those members at a particular moment in time.

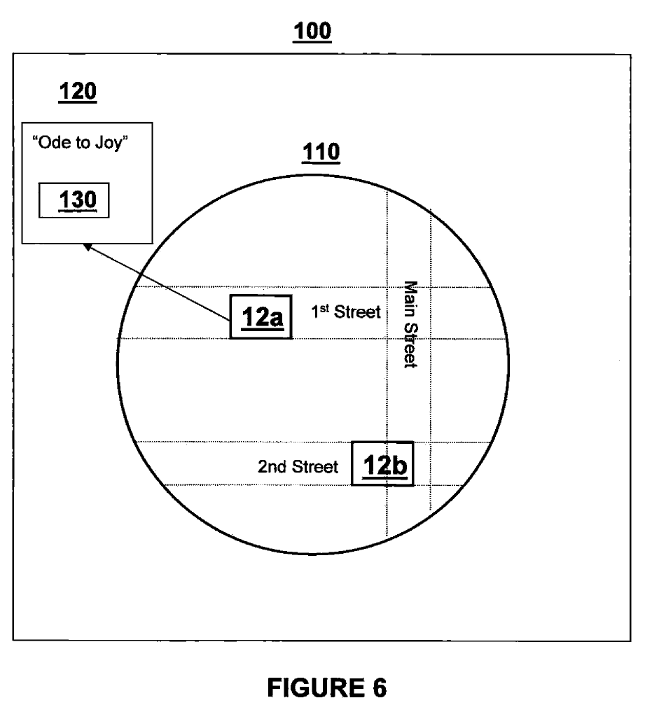

FIG. 6 shows an exemplary graphical user interface for a mobile handset. It shows display screen 100 of mobile handset 12b. Display screen 100 generates a map 110 showing the geographic location of mobile handset 12a and mobile handset 12b. Display screen 100 displays content information 120 concerning mobile handset 12a. In this example, the mobile handset 12a is playing “Ode to Joy” at that particular moment in time (for example, as a music clip, ring tone, streaming audio, etc.). Content information 120 shows information about that content, for example, the title (“Ode to Joy”), cover art, artist information, metadata, etc. Content information 120 optionally includes selector 130 that permits the user of mobile handset 12b to perform an action relating to mobile handset 12a, the user of mobile handset 12a, and/or the content associated with content information 120. For example, selector 130 can include a button that permits the user of mobile handset 12b to purchase or sample the content associated with content information 120 (for example, to listen to a clip of “Ode to Joy), or to communicate with mobile handset 12a (for example, to send an SMS message, email, or a message via a social networking communication mechanism). One benefit of this embodiment is that the user of mobile handset 12b will know that the user of mobile handset 12a is nearby and will learn what he or she is doing at that moment in time with regard to digital content.

Although this patent has discussed social networks from time to time, the same concepts can be applied to other groups or characteristics of users. For example, the same actions described previously with reference to FIG. 5 can be applied to all users who subscribe to the same service (e.g., a streaming radio service) or who have other characteristics in common (e.g., all users who have identified themselves as fans of a particular musical group), instead of all users who are part of the same social network.

The above described systems and methods also may be used with the system and method for transferring digital content that are described in U.S. patent application Ser. No. 11/788,711 filed on Apr. 20, 2007 and entitled “Method And Apparatus For Transferring Digital Content From A Personal Computer To A Mobile Handset” and U.S. patent application Ser. No. 12/355,546 filed on Jan. 16, 2009 and entitled “Method And Apparatus For Transferring Digital Content From A Personal Computer To A Mobile Handset”, both of which are incorporated herein by reference. The above described systems and methods also may be used with the system and method for creating, using, and disseminating audio clips that are described in U.S. patent application Ser. No. 12/167,860 filed on Jul. 3, 2008 and entitled “Method and Apparatus for Creating, Using, and Disseminating Audio Clips,” which is incorporated herein by reference.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A system for content social networking, comprising:
a computer having a networking unit and a content storage that stores one or more pieces of digital content and a library of the pieces of digital content for each user of the system;
one or more mobile handsets that can connect to the computer over a link, wherein each mobile handset has a unit for interacting with a piece of digital content and a unit for communicating an identifier of the interacted piece of digital content to the computer;
the networking unit further comprising a content identification unit that determines if the interacted piece of digital content is stored in the content storage and a network unit that generates a service with the interacted piece of digital content for one or more different mobile handsets based on the interacted piece of digital content.

2. The system of claim 1, wherein the network unit sends the interacted with piece of digital content to a different mobile handset when the interacted piece of digital content is part of the library of the user associated with the different mobile handset.

3. The system of claim 2, wherein the network unit sends the user of the different mobile handset an invitation to purchase the interacted piece of digital content when the interacted piece of digital content is not part of the library of the user associated with the different mobile handset.

4. The system of claim 1, wherein the computer further comprises a geography unit that determines the users of the system that are within a geographic area and wherein the network unit generates a service with the interacted piece of digital content for one or more different mobile handsets within the geographic area based on the interacted piece of digital content.

5. The system of claim 4, wherein the network unit sends the interacted with piece of digital content to a different mobile handset when the interacted piece of digital content is part of the library of the user associated with the different mobile handset.

6. The system of claim 4, wherein the network unit sends the user of the different mobile handset an invitation to purchase the interacted piece of digital content when the interacted piece of digital content is not part of the library of the user associated with the different mobile handset.

7. The system of claim 1, wherein the link further comprises one of a wireless link and a wired link.

8. The system of claim 1, wherein each piece of digital content further comprises a picture, a piece of music, a video, a podcast, a piece of text, an application and a radio feed.

9. The system of claim 4, wherein each mobile handset further comprises a geography unit that determines a location of the mobile handset and provides the location to the geography unit of the computer.

10. The system of claim 9, wherein the geography unit of each mobile handset further comprises a global positioning satellite unit.

11. A computer and mobile handset based method for content social networking, the computer having a networking unit and a content storage that stores one or more pieces of digital content and a library of the pieces of digital content for each user of the system, the one or more mobile handsets being able to connect to the computer over a link, the method comprising:
interacting, on a mobile handset, with a piece of digital content;
communicating, from the mobile handset, an identifier of the interacted piece of digital content to the computer;
determining, at the computer, if the interacted piece of digital content is stored in the content storage; and
generating, at the computer, a service with the interacted piece of digital content for one or more different mobile handsets based on the interacted piece of digital content.

12. The method of claim 11, wherein generating the service further comprises sending the interacted with piece of digital content to a different mobile handset when the interacted piece of digital content is part of the library of the user associated with the different mobile handset.

13. The method of claim 11, wherein generating the service further comprises sending the user of the different mobile handset an invitation to purchase the interacted piece of digital content when the interacted piece of digital content is not part of the library of the user associated with the different mobile handset.

14. The method of claim 11 further comprising determining, at the computer, the users of the system that are within a geographic area and wherein generating the service further comprises generating a service with the interacted piece of digital content for one or more different mobile handsets within the geographic area based on the interacted piece of digital content.

15. The method of claim 14, wherein generating the service further comprises sending the interacted with piece of digital content to a different mobile handset when the interacted piece of digital content is part of the library of the user associated with the different mobile handset.

16. The method of claim 14, wherein generating the service further comprises sending the user of the different mobile handset an invitation to purchase the interacted piece of digital content when the interacted piece of digital content is not part of the library of the user associated with the different mobile handset.

17. The method of claim 11, wherein each piece of digital content further comprises a picture, a piece of music, a video, a podcast, a piece of text, an application and a radio feed.

18. The method of claim 14 further comprising determining, at each mobile handset, a location of the mobile handset and provides the location to the computer.

19. A system for sharing content, comprising:
a first mobile handset comprising a geography unit used to determine the location of said first mobile handset and a storage device that stores a piece of digital content;
a second mobile handset programmed to indicate the location of said first mobile handset and to perform an action relating to said piece of digital content;
a computing device for communicating with said first mobile handset and said second mobile handset.

20. The system of claim 19, wherein said geography unit is a GPS unit.

21. The system of claim 19, wherein said piece of digital content comprises digital music.

22. The system of claim 21, wherein said action comprises playing digital music.

23. The system of claim 21, wherein said action comprises displaying one or more of song information, artist information, or cover art.

24. The system of claim 21, wherein said digital music is a ringtone.
